(19) United States
(12) Patent Application Publication
(10) Pub. No.: US 2021/0158435 A1
(43) Pub. Date: May 27, 2021

(54) VEHICLE, INFORMATION PROCESSING APPARATUS, AND OPERATIONS MANAGEMENT METHOD

(71) Applicant: TOYOTA JIDOSHA KABUSHIKI KAISHA, Toyota-shi (JP)

(72) Inventors: Yuki Tatsumoto, Nagoya-shi (JP); Saori Matsumoto, Chofu-shi (JP); Keigo Yamada, Toyota-shi (JP); Akira Sasaki, Miyoshi-shi (JP); Mitsuhiro Miura, Toyota-shi (JP)

(73) Assignee: TOYOTA JIDOSHA KABUSHIKI KAISHA, Toyota-shi (JP)

(21) Appl. No.: 17/078,715

(22) Filed: Oct. 23, 2020

(30) Foreign Application Priority Data
Nov. 22, 2019 (JP) 2019-211120

(51) Int. Cl. G06Q 30/06; G06Q 10/02; G06Q 30/02; G06Q 50/30; H04W 4/02; H04W 4/40

(52) U.S. Cl. CPC G06Q 30/0645; G06Q 10/02; H04W 4/40; G06Q 50/30; H04W 4/025; G06Q 30/0207

(57) ABSTRACT

A vehicle includes a container capable of housing a mobile object to be used by a user. The vehicle is configured to, in accordance with use request information for the mobile object from the user, move to at least one of a location at which the user is to rent the mobile object and a location at which the user is to return the mobile object.

### CROSS-REFERENCE TO RELATED APPLICATION

This application claims priority to JP 2019-211120 filed on Nov. 22, 2019, the entire disclosure of which is incorporated herein by reference.

### TECHNICAL FIELD

The present disclosure relates to a vehicle, an information processing apparatus, and an operations management method.

### BACKGROUND

Bicycle rental systems are known. For example, JP 2016-162248 A (PTL 1) discloses a system in which bicycles are rented out from a bicycle parking lot established within a vehicle parking lot.

### CITATION LIST

### Patent Literature

PTL 1: JP 2016-162248 A

### SUMMARY

To rent or return mobile objects such as rental bicycles, users need to visit facilities such as bicycle parking lots. It is thus desired to improve the convenience in providing mobile objects for users.

The present disclosure has been made in consideration of the above circumstances, and an object thereof is to improve the convenience in providing mobile objects for users.

A vehicle according to an embodiment of the present disclosure includes a container capable of housing a mobile object to be used by a user. The vehicle is configured to, in accordance with use request information for the mobile object from the user, move to a target location that is determined as at least one of a location at which the user is to rent the mobile object and a location at which the user is to return the mobile object.

An information processing apparatus according to an embodiment of the present disclosure includes a controller configured to control an operation of a first vehicle configured to be capable of housing a mobile object to be used by a user and a communication interface configured to be communicatively connected to the first vehicle and a terminal apparatus in the possession of the user. The controller is configured to receive use request information for the mobile object from the terminal apparatus via the communication interface and control, in accordance with the use request information, operation of the first vehicle to cause the first vehicle to move to a target location that is determined as at least one of a location at which the user is to rent the mobile object and a location at which the user is to return the mobile object.

An operations management method according to an embodiment of the present disclosure includes a step in which an information processing apparatus configured to control an operation of a first vehicle configured to be capable of housing a mobile object to be used by a user receives use request information for the mobile object from a terminal apparatus in the possession of the user and a step in which the information processing apparatus controls, in accordance with the use request information, operation of the first vehicle to cause the first vehicle to move to a target location that is determined as at least one of a location at which the user is to rent the mobile object and a location at which the user is to return the mobile object.

The vehicle, the information processing apparatus, and the operations management method according to an embodiment of the present disclosure can improve the convenience in providing mobile objects for users.

### BRIEF DESCRIPTION OF THE DRAWINGS

In the accompanying drawings:

FIG. 1 is a diagram schematically illustrating a configuration example of an operations management system according to an embodiment;

FIG. 2 is a block diagram illustrating a configuration example of the operations management system according to the embodiment;

FIG. 3 is a side view of a configuration example of a container; and

FIG. 4 is a flowchart illustrating an example of a procedure performed by a server.

### DETAILED DESCRIPTION

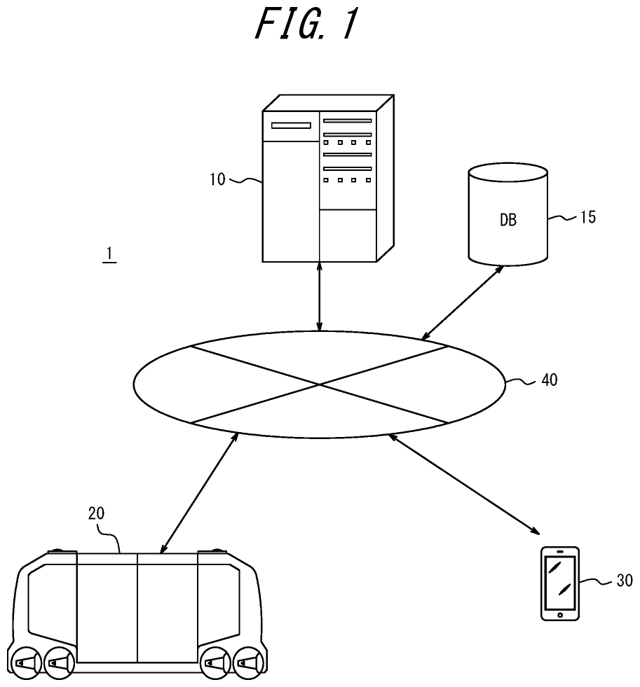

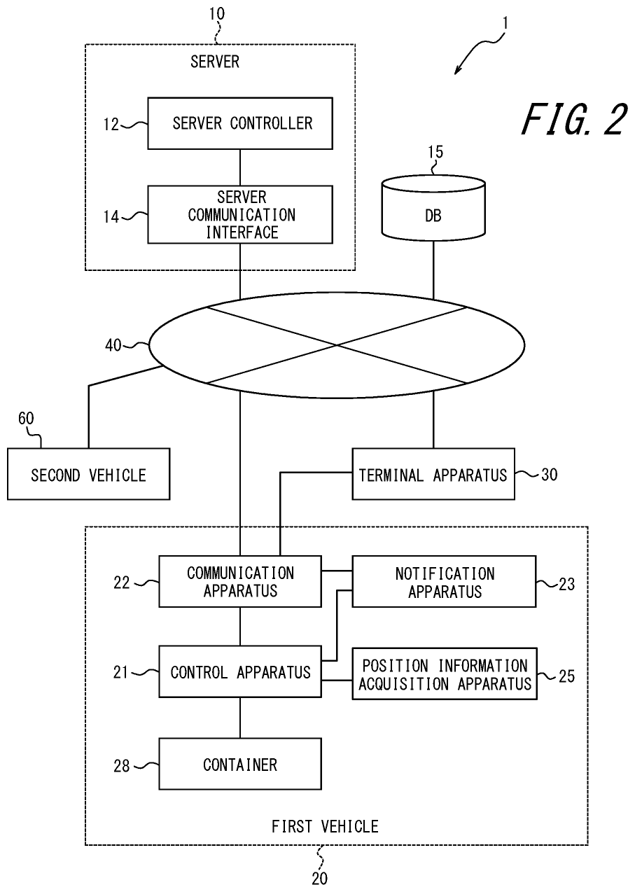

As illustrated in FIGS. 1 and 2, an operations management system 1 according to an embodiment includes a server 10, a first vehicle 20, and a terminal apparatus 30. Additionally, but optionally, the operations management system 1 includes a database (DB) 15. The server 10, the first vehicle 20, the terminal apparatus 30, and the DB 15 are connected to a network 40 and capable of communicating with each other. Each of the server 10, the first vehicle 20, the terminal apparatus 30, and the DB 15 is not limited to one in number and may be two or more.

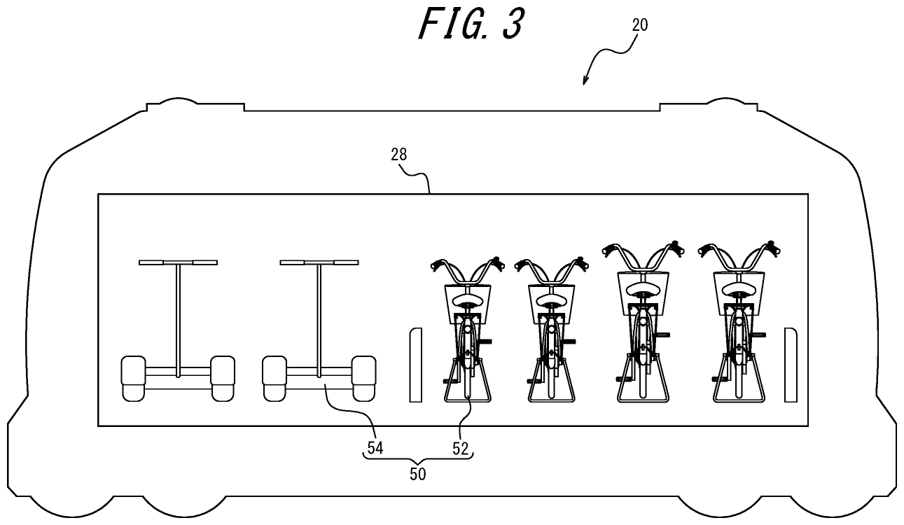

The first vehicle 20 includes a container 28. The container 28 is configured to be capable of housing a mobile object 50 (refer to FIG. 3) to be rented out to a user. The mobile object 50 may be configured to have a capacity of one person. The mobile object 50 may include a two-wheeled vehicle, such as a bicycle 52 (refer to FIG. 3) or a motorbike. The mobile object 50 may include a three-wheeled vehicle. The mobile object 50 may include a wheelchair. The mobile object 50 may include a parallel two-wheeled vehicle 54 (refer to FIG. 3), such as Segway® (Segway is a registered trademark in Japan, other countries, or both) and Ninebot® (Ninebot is a registered trademark in Japan, other countries, or both). The mobile object 50 may include a one-wheeled vehicle. The mobile object 50 may include a personal mobility device, such as Ha:mo® (Ha:mo is a registered trademark in Japan, other countries, or both). The mobile object 50 is not limited to these examples and may include various transporters that assist in transportation of a user. The first vehicle 20 moves to a location at which a user can rent the mobile object 50 from the container 28 or a location at which a user can return the mobile object 50 to the container 28. The first vehicle 20 is also simply referred to as the vehicle.

When a user desires to rent or return the mobile object 50, the operations management system 1 arranges the first vehicle 20 equipped with the container 28 in accordance with a request from the user. The operations management system 1 manages operations of the first vehicle 20 to control the first vehicle 20 to move to a destination that is a location at which the user is to rent or return the mobile object 50. The user has the terminal apparatus 30 and accesses the server 10 from the terminal apparatus 30 to request rental or return of the mobile object 50. The server 10 accepts the request from the user. In accordance with the request from the user, the server 10 arranges the first vehicle 20 equipped with the container 28. The server 10 may control an operation route or an operation schedule for the first vehicle 20 equipped with the container 28. The server 10 may determine whether it is possible accept the request from the user in accordance with an operational state of the first vehicle 20. The server 10 may determine the operation route or the operation schedule for the first vehicle 20 in accordance with the result obtained by accepting the request from the user. The service in which the first vehicle 20 operates in accordance with the request from the user and assists the user to rent or return the mobile object 50 is also referred to as an on-demand rental service. The operations management system 1 can provide the on-demand rental service.

The server 10 may include one server apparatus or a plurality of server apparatuses that are capable of communicating with each other. The server 10 is also referred to as an information processing apparatus. The server 10 may be operated by, for example, an entity that provides the on-demand rental service. The server 10 accepts requests from users and also manages the usage state of the mobile object 50. The server 10 may send and receive various kinds of information regarding the on-demand rental service to and from the first vehicle 20. The server 10 may be configured to be capable of performing not only these kinds of processing but also various kinds of processing regarding the on-demand rental service. The server 10 manages operations of the first vehicle 20. The server 10 may communicate with the first vehicle 20 to obtain various kinds of information about the first vehicle 20, such as the position and the speed of the first vehicle 20. The server 10 may be configured to be capable of performing not only these kinds of processing but also various kinds of processing for managing operations of the first vehicle 20.

The server 10 includes a server controller 12 and a server communication interface 14. The server controller 12 is also simply referred to as a controller. The server controller 12 may include one or more processors. In the present embodiment, a “processor” is, but not limited to, a general processor, a processor dedicated to a particular processing operation, or the like. The server controller 12 may include one or more dedicated circuits. The dedicated circuit may include, for example, a field-programmable gate array (FPGA) or an application-specific integrated circuit (ASIC). The server controller 12 may include a dedicated circuit instead of a processor or include a dedicated circuit together with a processor.

The server communication interface 14 is also simply referred to as a communication interface. The server communication interface 14 may include a communication module and communicate with the first vehicle 20. The server 10 may further include a data store. The data store may be, for example, but is not limited to, a semiconductor memory, a magnetic memory, an optical memory, or the like. The data store may function as, for example, a primary storage unit, an auxiliary storage unit, or a cache memory. The data store may include an electromagnetic storage medium, such as a magnetic disk. The data store may include a non-transitory computer-readable medium. The data store stores any information that is used for operation of the server 10. The data store may store, for example, a system program and an application program. The server 10 may use the DB 15 as the data store and store, for example, programs or information. The data store may be included in the server controller 12.

The first vehicle 20 includes a control apparatus 21 and a communication apparatus 22. The control apparatus 21 and the communication apparatus 22 are communicatively connected to each other via, for example, an in-vehicle network such as a controller area network (CAN) or a dedicated line.

The control apparatus 21 controls individual components included in the first vehicle 20. The control apparatus 21 may include one or more processors. The control apparatus 21 may include one or more dedicated circuits instead of one or more processors or include one or more dedicated circuits together with one or more processors. The control apparatus 21 may further include a data store.

The communication apparatus 22 communicates with the server 10 through the network 40. The communication apparatus 22 may communicate with the terminal apparatus 30 through the network 40, or may communicate with the terminal apparatus 30 without going through the network 40. The communication apparatus 22 may be, for example, an on-board communication device. The communication apparatus 22 may include a communication module that establishes a connection with the network 40. For example, the communication module may include a communication module compliant with mobile communication standards such as the fourth generation (4G) standard and the fifth generation (5G) standard, but the communication module is not limited to this example.

Additionally, but optionally, the first vehicle 20 includes a position information acquisition apparatus 25. The position information acquisition apparatus 25 is communicatively connected to the other components installed in the first vehicle 20 via the in-vehicle network such as the CAN or dedicated lines. The position information acquisition apparatus 25 obtains position information for the first vehicle 20. The position information acquisition apparatus 25 may include a receiver for a satellite navigation system. The receiver for a satellite navigation system may include, for example, a global positioning system (GPS) receiver. In the present embodiment, the first vehicle 20 is configured to obtain position information for the first vehicle 20 by using the position information acquisition apparatus 25. The first vehicle 20 may output the position information for the first vehicle 20 to the server 10 or the terminal apparatus 30.

The first vehicle 20 is configured to be capable of moving to locations at which users rent or return the mobile object 50. The first vehicle 20 may be configured to be operated by a driver. The first vehicle 20 may be configured to be capable of operating by automated driving. The automated driving may be performed, for example, at any level of Levels 1 to 5 as defined by the Society of Automotive Engineers (SAE). Standards under which the automated driving is performed are not limited to this example and may be other standards.

When the first vehicle 20 is controlled by automated driving, the control apparatus 21 controls driving of the first vehicle 20. The server 10 outputs to the first vehicle 20 control information including information that specifies a destination for the first vehicle 20. The control apparatus 21 controls driving of the first vehicle 20 in accordance with the control information outputted by the server 10 and causes the first vehicle 20 to move to the destination.

Additionally, but optionally, the first vehicle 20 includes a notification apparatus 23. The notification apparatus 23 is communicatively connected to the other components installed in the first vehicle 20 via the in-vehicle network such as the CAN or dedicated lines. The notification apparatus 23 notifies the driver of the first vehicle 20 of information.

The notification apparatus 23 may notify the driver of information in the form of, for example, visual information, such as images, characters, or diagrams. In this case, the notification apparatus 23 may be configured as a display device. The display device may include a light emitting device, such as a light emission diode (LED). The display device may be, for example, a liquid crystal display (LCD). The display device may be an organic or inorganic electroluminescent (EL) display. The display device may be a plasma display panel (PDP). The display device is not limited to these examples and may be a display of various other types.

The notification apparatus 23 may notify the driver of information in the form of, for example, auditory information, such as audio. In this case, the notification apparatus 23 may be configured as a device for outputting sound, such as a speaker. The notification apparatus 23 is not limited to this example and may be configured as a device of various other kinds.

The first vehicle 20 may be operated by a driver rather than automated driving. In this case, the notification apparatus 23 may obtain, from the server 10, information that specifies a destination for the first vehicle 20 and notifies the driver of the destination of the first vehicle 20. The driver drives the first vehicle 20 to move to the destination obtained from the notification apparatus 23.

The terminal apparatus 30 communicates with the first vehicle 20 through or without going through the network 40. The terminal apparatus 30 communicates with the server 10 through the network 40. The terminal apparatus 30 may include, for example, a portable terminal such as a smartphone.

The terminal apparatus 30 may run an application used by the user to request rental or return of the mobile object 50. The terminal apparatus 30 may communicate with the server 10 and send or receive information indicating that the user requests rental or return of the mobile object 50. The information indicating that the user requests rental or return of the mobile object 50 is also referred to as use request information. The terminal apparatus 30 may use the application on which the user inputs use request information.

The terminal apparatus 30 may include, for example, a configuration identical or similar to the configuration of the position information acquisition apparatus 25 installed in the first vehicle 20 so as to obtain position information of the terminal apparatus 30. The terminal apparatus 30 may output the position information of the terminal apparatus 30 to the server 10 or the first vehicle 20.

As illustrated in FIG. 3, the first vehicle 20 includes the container 28. The container 28 is configured to be capable of housing at least one mobile object 50. The container 28 may house, for example, the bicycle 52 or the parallel two-wheeled vehicle 54 as the mobile object 50. The container 28 may be managed by an administrator. In this case, the mobile object 50 is rented out from the container 28 or returned to the container 28 in the presence of the administrator. This operation can prevent the mobile object 50 from being taken out without permission.

The container 28 may be provided with a locking mechanism for the purpose of controlling rental of the mobile object 50. The container 28 may lock the mobile object 50 housed in the container 28 to prevent the mobile object 50 from being taken away by a user who has not requested rental of the mobile object 50. The locking mechanism of the container 28 may be controlled by the control apparatus 21. The container 28 may include a processor for controlling the locking mechanism.

When the mobile object 50 housed in the container 28 is rented out, the container 28 may unlock the mobile object 50 in accordance with information from the server 10 or the terminal apparatus 30. In a case in which a user who requests rental of the mobile object 50 is authenticated, the container 28 may unlock the mobile object 50. The container 28 may verify a user by using the terminal apparatus 30 in the possession of the user.

The container 28 outputs information about the rental and return state of the mobile object 50 to the server 10. The server controller 12 of the server 10 determines whether to accept a request from a user in accordance with the rental and return state of the mobile object 50.

The container 28 may be communicatively connected to the server 10 or the terminal apparatus 30 via the control apparatus 21, and the communication apparatus 22 or the network 40. In a case in which the container 28 includes the processor for controlling the locking mechanism, the container 28 may be communicatively connected to the server 10 or the terminal apparatus 30 via the communication apparatus 22 or the network 40. In a case in which the container 28 includes the processor for controlling the locking mechanism, the container 28 may be communicatively connected directly to the terminal apparatus 30 through near-field communication (NFC), infrared communication, or the like.

Acceptance of Use Requests

The server controller 12 obtains, as use request information, information about a location at which a user desires to rent or return the mobile object 50. The location at which a user desires to rent or return the mobile object 50 is also referred to as a desired location. Information that specifies a desired location is also referred to as desired location information. The server controller 12 selects first vehicles 20 that can travel to a desired location in accordance with desired location information. The server controller 12 further selects from among the selected first vehicles 20 a first vehicle 20 that houses the mobile object 50 available for rental to the user or that can house the mobile object 50 to be returned by the user. In accordance with operational information for the selected first vehicle 20, the server controller 12 determines a location at which the user can actually rent or return the mobile object 50. The location at which a user can actually rent or return the mobile object 50 is also referred to as a target location. Information that specifies a target location is also referred to as target location information. The server controller 12 outputs target location information to the selected first vehicle 20. The first vehicle 20 operates to move to the target location in accordance with the target location information.

The desired location may be specified by using, for example, an address, or a latitude and a longitude. In a case in which the desired location is specified as a single point or a narrow range, the number of first vehicles 20 that satisfy the requirements may decrease. The desired location may be specified by information indicating an allowable range as a location at which a user can actually rent or return the mobile object 50. For example, the desired location information may include information indicating how far away a location at which a user can actually rent or return the mobile object 50 is allowed to be from a desired location selected by the user. Specifically, an allowable distance may be specified as a distance from a desired location selected by a user to a location at which the user can actually rent or return the mobile object 50.

The desired location may be specified by information indicating a predetermined range. The predetermined range is specified as, for example, an address. The predetermined range may be specified as a boundary that defines the predetermined range. The boundary may be determined as a line connecting a plurality of locations. The predetermined range may be determined as a range defined by a particular route.

The server controller 12 may further obtain, as use request information, information about a time at which a user desires to rent or return the mobile object 50. The time at which a user desires to rent or return the mobile object 50 is also referred to as a desired time. Information about a desired time is also referred to as desired time information. The server controller 12 selects first vehicles 20 that can drive to a desired location by a time specified by desired time information. The server controller 12 further selects from among the selected first vehicles 20 a first vehicle 20 that houses the mobile object 50 available for rental to the user or that can house the mobile object 50 to be returned by the user. In accordance with operational information of the selected first vehicle 20, the server controller 12 determines a location and a time at which the user can actually rent or return the mobile object 50. The time at which a user can actually rent or return the mobile object 50 is also referred to as a target time. Information about a target time is also referred to as target time information. The server controller 12 outputs target location information and target time information to the selected first vehicle 20. The first vehicle 20 operates to move to the target location by the target time in accordance with the target location information and the target time information.

The desired time may be specified as a particular time. In a case in which the desired time is specified as a single point in time or a narrow range, the number of first vehicles 20 that satisfy the requirements may decrease. The desired time may be specified by information indicating an allowable range as a time at which a user can actually rent or return the mobile object 50. For example, the desired time information may include information indicating how much earlier or later a time at which a user can actually rent or return the mobile object 50 is allowed to be than a desired time selected by the user. Specifically, an allowable time length may be specified as a time distance from a desired time selected by a user that the user can accept.

The desired time may be specified as a predetermined timeslot. The predetermined timeslot may be determined as a timeslot between the earliest time and the latest time that a user is able to accept.

The server controller 12 may select the first vehicle 20 that is scheduled to operate on a route that passes through a target location selected by a user. The server controller 12 may select the first vehicle 20 that is scheduled to operate on a route that passes through a desired location at a desired time selected by a user. When the server controller 12 determines the selected first vehicle 20 to be used by a user to rent or return the mobile object 50, the server controller 12 specifies the desired location and the desired time as a target location and a target time.

The use request information further includes information that specifies whether a user requests rental or return of the mobile object 50. Information that specifies whether a user requests rental or return of the mobile object 50 is also referred to as use purpose information. The use request information may further include information specifying the type of the mobile object 50. The type of the mobile object 50 includes, for example, the bicycle 52 and the parallel two-wheeled vehicle 54. The use request information may include other kinds of information in addition to desired location information, desired time information, and use purpose information. In a case in which a first vehicle 20 satisfies the requirements specified by use request information, the server controller 12 determines to accept the use request.

Rental of Mobile Objects

When a user requests rental of the mobile object 50, the server controller 12 at least determines whether a first vehicle 20 housing a mobile object 50 that is available for rental to the user exists. The server controller 12 may determine whether a first vehicle 20 housing the mobile object 50 that is available for rental to the user is among first vehicles 20 that satisfy requirements specified by desired location information or other kinds of information such as desired time information. In a case in which a plurality of the first vehicles 20 satisfy the requirements specified by use request information, the server controller 12 may send, to the terminal apparatus 30, information about the plurality of the first vehicles 20 satisfying the requirements. The terminal apparatus 30 may present the plurality of the first vehicles 20 satisfying the requirements to the user so that the user can make an input to select a first vehicle 20 from among the plurality of the first vehicles 20. The server controller 12 may send to the terminal apparatus 30 information about the mobile objects 50 that are housed in the containers 28 of the plurality of the first vehicles 20 that satisfy the requirements and that are available for rental to the user. The terminal apparatus 30 may present, to the user, the mobile objects 50 available for rental to the user, so that the user can make an input to select a mobile object 50 from among the mobile objects 50. The server controller 12 may select a first vehicle 20 in accordance with information inputted by the user to the terminal apparatus 30.

In accordance with operational information for the selected first vehicle 20, and a desired location and a desired time, the server controller 12 determines a target location and a target time. In a case in which at least either the target location or the target time does not meet the requirements of the user, the user may decide not to rent the mobile object 50. In this case, the terminal apparatus 30 may receive an input of the decision result made by the user and output the inputted information to the server 10.

In a case in which a plurality of the first vehicles 20 satisfy requirements, the server controller 12 selects one first vehicle 20 from among the plurality of the first vehicles 20. The server controller 12 may select, for example, a first vehicle 20 that can move to a location closest to a desired location selected by the user or that can move to a desired location by a time closest to a desired time selected by the user. The server controller 12 determines a target location and a target time in accordance with operational information for the selected first vehicle 20 and controls the operation of the selected first vehicle 20 to cause the first vehicle 20 to move to the target location by the target time.

When the first vehicle 20 is determined, the server controller 12 notifies the terminal apparatus 30 in the possession of the user of the target location and the target time in a case in which the user is to rent the mobile object 50. In accordance with the sent information, the user moves to the target location, that is, a location at which the user can rent the mobile object 50, and consequently, the user can rent the mobile object 50 from the first vehicle 20.

Return of Mobile Objects

When a user requests return of the mobile object 50, the server controller 12 at least determines whether a first vehicle 20 that can house the mobile object 50 to be returned by the user exists. The server controller 12 may determine whether the first vehicle 20 that can house the mobile object 50 to be returned by the user is among first vehicles 20 that satisfy the requirements specified by desired location information or other kinds of information such as desired time information. In a case in which a plurality of the first vehicles 20 satisfy requirements specified by use request information, the server controller 12 may send, to the terminal apparatus 30. information about the plurality of the first vehicles 20 that satisfy the requirements. The terminal apparatus 30 may present the plurality of the first vehicles 20 that satisfy the requirements to the user so that the user can make an input to select a first vehicle 20 from among the plurality of the first vehicles 20. The server controller 12 may select a first vehicle 20 in accordance with information inputted by the user to the terminal apparatus 30.

In accordance with operational information for the selected first vehicle 20, and a desired location and a desired time, the server controller 12 determines a target location and a target time. In a case in which at least either the target location or the target time does not meet the requirements of the user, the user may decide not to return the mobile object 50. In this case, the terminal apparatus 30 may receive an input of the decision result made by the user and output the inputted information to the server 10.

In a case in which a plurality of the first vehicles 20 satisfy requirements, the server controller 12 selects one first vehicle 20 from among the plurality of the first vehicles 20. The server controller 12 may select, for example, a first vehicle 20 that can move to a location closest to a desired location selected by the user or that can move to a desired location by a time closest to a desired time selected by the user. The server controller 12 controls the operation of the selected first vehicle 20 to cause the first vehicle 20 to move to a target location by a target time.

When the first vehicle 20 is determined, the server controller 12 notifies the terminal apparatus 30 in the possession of the user of the target location and the target time in a case in which the user is to return the mobile object 50. In accordance with the sent information, the user moves to the target location, that is, a location at which the user can return the mobile object 50, and consequently, the user can return the mobile object 50 to the first vehicle 20.

The location at which a user can return the mobile object 50 may differ from a location at which the user rents the mobile object 50. This configuration increases the flexibility for travel by the user. As a result, the convenience for users is improved.

Incentives

In a case in which the distance between a desired location included in user's use request information and a determined target location is equal to or greater than a predetermined distance, the server controller 12 may provide an incentive to a user who accepts that the user is to rent or return the mobile object 50 at the target location. In a case in which the difference between a desired time included in user's use request information and a determined target time is equal to or greater than a predetermined time, the server controller 12 may provide an incentive to a user who accepts that the user is to rent or return the mobile object 50 at the target time.

The incentive may be provided, for example, such that the use fee for the on-demand rental service is reduced for the user. The incentive may be provided as points that can be used for payment of the use fee for the on-demand rental service. The incentive may be provided as electronic money. The incentive may be provided as points that can be exchanged for valuables or paid-for services.

The server controller 12 may output information about an incentive to the terminal apparatus 30 in the possession of a user. The server controller 12 may increase the incentive provided for a user as the distance between a target location and a desired location increases or the time difference between a target time and a desired time increases.

Since the incentive is provided to users, it is possible to ease the requirements used in selecting the first vehicle 20. As a result, the operating efficiency of the first vehicle 20 is improved.

Usage Checking and Charge Processing

After the server controller 12 controls the first vehicle 20 to move to a target location, the server controller 12 may check whether a user actually rents or returns the mobile object 50. The server controller 12 may obtain information about whether the mobile object 50 is taken out from the container 28 or taken in the container 28.

In a case in which, after the first vehicle 20 has reached a target location and a determined target time passed, the server controller 12 cannot determine that a user has actually rented or returned the mobile object 50 within a predetermined time, the server controller 12 may determine that the user has not rented or returned the mobile object 50. The server controller 12 may automatically cancel the user's request or output a notification for checking whether to cancel the request to the terminal apparatus 30 of the user.

When a user has actually rented or returned the mobile object 50, the server controller 12 may charge a use fee to the user. When a user cancels a request, the server controller 12 may charge a cancellation fee to the user. The user may previously input on the terminal apparatus 30 information about a payment method for fees such as the use fee and the cancellation fee. The server controller 12 may obtain the information about a payment method for fees from the terminal apparatus 30 and output to the terminal apparatus 30 information for making payment. The payment method for fees may include credit card, account transfer, and payment methods using electronic money. The payment method for fees may include a payment method using points that can be exchanged for valuables or paid-for services. The payment method for fees is not limited to these examples and may include various methods.

When a user rents the mobile object 50, the server controller 12 may calculate and charge the use fee in accordance with a length of time from when the mobile object 50 is rented out to the user to when the user returns the mobile object 50. The server controller 12 may calculate and charge the use fee also in accordance with a length of time from when a request for rental of the mobile object 50 is accepted from the user to when the mobile object 50 is actually rented out to the user. When the user is expected, as a rental condition, to return the mobile object 50 within a predetermined time period, the server controller 12 may charge a given amount at a time when the mobile object 50 is rented out.

When a user cancels a request for rental of the mobile object 50, the server controller 12 may calculate and charge a cancellation fee in accordance with a length of time from when the request for rental of the mobile object 50 was accepted from the user to when the request for rental of the mobile object 50 is canceled. To accept a use request, the server controller 12 may give a lower priority to a use request from a user who has previously canceled than a priority given to a use request from another user who has not previously canceled.

In a case in which a time period for which a user is renting the mobile object 50 exceeds a predetermined time period, the server controller 12 may output, to the terminal apparatus 30 of the user, a notification that requests return of the mobile object 50. In a case in which a time period for which a user is renting the mobile object 50 exceeds a predetermined time period, the server controller 12 may also charge a penalty fee. When the user starts rental of the mobile object 50, the server controller 12 may estimate a time period for which the user is expected to rent the mobile object 50 in accordance with use request information and charge the use fee based on the estimated time period as an advance payment.

As described above, the operations management system 1 according to the present embodiment can provide the on-demand rental service for users. As a result, the convenience for users who use the mobile object 50 is improved.

Cooperation with On-Demand Buses

As illustrated in FIG. 2, additionally, but optionally, the operations management system 1 involves a second vehicle 60 that can be boarded by a user. The second vehicle 60 may be operated as an on-demand bus. The server communication interface 14 of the server 10 is communicatively connected to the second vehicle 60. The server controller 12 of the server 10 obtains operational information for the second vehicle 60 via the server communication interface 14. The operational information for the second vehicle 60 may include a route on which the second vehicle 60 operates or an operation schedule.

A user may board the second vehicle 60 and travel to rent the mobile object 50 from the first vehicle 20 at a location at which the user alights from the second vehicle 60. A user may return the mobile object 50 to the first vehicle 20 and board the second vehicle 60 at the location at which the user returns the mobile object 50. In other words, a user may use the mobile object 50 and the second vehicle 60 in combination.

In a case in which a user uses the first vehicle 20 and the second vehicle 60 in combination, the server controller 12 may generate target location information for the first vehicle 20 in accordance with use request information and operational information for the second vehicle 60. For example, assume that a user requests rental of the mobile object 50 at a location at which the user alights from the second vehicle 60. In this case, the server controller 12 may generate target location information for the first vehicle 20 that minimizes the time period from when the user is to alight from the second vehicle 60 at a location to when the first vehicle 20 is to reach the location. Additionally, the server controller 12 may generate target location information for the first vehicle 20 that minimizes the distance between the location at which the user is to alight from the second vehicle 60 and a target location for the first vehicle 20.

Since the operations management system 1 causes the first vehicle 20 and the second vehicle 60 to cooperate with each other, the convenience for users can be improved.

Example Operations Management Method

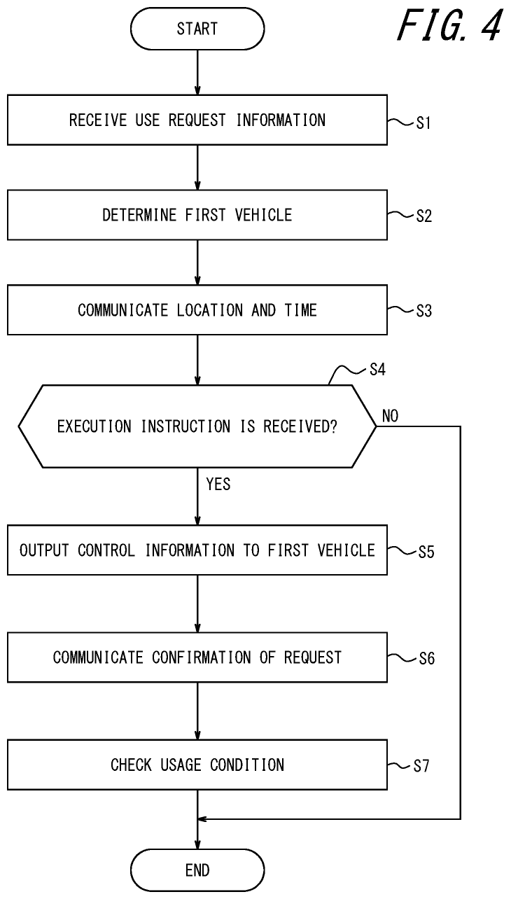

The server controller 12 may implement an operations management method including the procedure illustrated in the flowchart of FIG. 4 as an example. The operations management method may be implemented as an operations management program that can be run by a processor such as the server controller 12. The operations management program may be stored on a non-transitory computer-readable medium.

The server controller 12 receives use request information from the terminal apparatus 30 for a user by using the server communication interface 14 (step S1). The user can request rental or return of the mobile object 50 by operating their terminal apparatus 30 and inputting use request information. Specifically, the terminal apparatus 30 enables the user to input information indicating whether the user desires to rent or return the mobile object 50. The terminal apparatus 30 enables the user to specify a target location. The terminal apparatus 30 may enable the user to specify a target time. The terminal apparatus 30 may enable the user to input a type of the mobile object 50 that the user desires to rent. The terminal apparatus 30 generates use request information including the information inputted by the user and outputs the use request information to the server 10. The server controller 12 may previously have registered the user as a member and stored information about the registered user. The server controller 12 may accept only requests for rental or return of the mobile object 50 that is submitted by users registered as members. The server controller 12 may give priority to requests for rental or return of the mobile object 50 submitted by users registered as members to accept requests.

The server controller 12 determines the first vehicle 20 in accordance with the use request information (step S2). Specifically, the server controller 12 selects first vehicles 20 that satisfy the requirements specified by the use request information. In a case in which the user desires to rent the mobile object 50, the server controller 12 determines the first vehicle 20 by also using, as a requirement, a condition that the first vehicle 20 houses the mobile object 50 available for rental to the user. In a case in which the user desires to return the mobile object 50, the server controller 12 determines the first vehicle 20 by also using, as a requirement, a condition that the first vehicle 20 can house the mobile object 50 to be returned by the user. When the server controller 12 cannot determine a first vehicle 20 satisfying the requirements specified by the use request information, the server controller 12 may output, to the terminal apparatus 30 of the user, a notification indicating that the request from the user cannot be accepted.

The server controller 12 determines a location as a candidate for the target location of the determined first vehicle 20 and a time as a candidate for the target time of the determined first vehicle 20 and communicates the location and the time to the terminal apparatus 30 of the user (step S3). The location as a candidate for the target location is also referred to as a candidate location. The time as a candidate for the target time is also referred to as a candidate time. Specifically, the server controller 12 determines a candidate location and a candidate time in accordance with an operation schedule of the determined first vehicle 20.

The server controller 12 determines whether an indication that the user decides to rent or return the mobile object 50 at the communicated candidate location at the communicated candidate time is received (step S4). Specifically, the terminal apparatus 30 of the user presents to the user the candidate location and the candidate time that are communicated by the server controller 12 in step S3 and assists the user to determine whether to accept rental or return of the mobile object 50 by the user at the candidate location at the candidate time. The terminal apparatus 30 receives an input indicating whether the candidate location and the candidate time are accepted from the user. In a case in which the user accepts rental or return of the mobile object 50 by the user at the communicated candidate location and the communicated candidate time, the terminal apparatus 30 instructs the server 10 to use the communicated candidate location and the communicated candidate time as the target location and the target time and perform processing for rental or return of the mobile object 50. The instruction to use the communicated candidate location and the communicated candidate time as the target location and the target time and perform processing for rental or return of the mobile object 50 is also referred to as an execution instruction. In a case in which the user does not accept rental or return of the mobile object 50 by the user at the communicated candidate location and at the communicated candidate time, the terminal apparatus 30 instructs the server 10 to not use the communicated candidate location and candidate time and not perform processing for rental or return of the mobile object 50. The instruction to not use the communicated candidate location and candidate time and not perform processing for rental or return of the mobile object 50 is also referred to as a non-execution instruction. In other words, the server controller 12 receives an execution instruction or a non-execution instruction.

In a case in which the server controller 12 does not receive an execution instruction (NO in step S4), that is, in a case in which the server controller 12 receives a non-execution instruction, the server controller 12 ends the procedure illustrated in the flowchart of FIG. 4. The server controller 12 may end the procedure illustrated in the flowchart of FIG. 4 after outputting to the terminal apparatus 30 a notification indicating that the request has failed.

In a case in which the server controller 12 receives an execution instruction (YES in step S4), the server controller 12 outputs control information to the first vehicle 20 (step S5). Specifically, the server controller 12 outputs control information for controlling the first vehicle 20 to move to the target location. In accordance with the control information, the first vehicle 20 drives to reach the target location by the target time.

The server controller 12 notifies the terminal apparatus 30 of the user that the request is confirmed (step S6). The server controller 12 may communicate the confirmed target location and target time. The user travels in accordance with the communicated target location and target time.

The server controller 12 checks whether the user has rented or returned the mobile object 50 (step S7). The server controller 12 may perform charging processing for the user at the time when the mobile object 50 is rented out or returned. After step S7, the server controller 12 ends the procedure illustrated in the flowchart of FIG. 4.

As described above, the server controller 12 according to the present embodiment executes the operations management method or the operations management program, so that the on-demand rental service is provided for users. As a result, the convenience for users who use the mobile object 50 is improved.

While the embodiments according to the present disclosure have been described with reference to the accompanying drawings and the examples, it should be understood that various changes and modifications based on the present disclosure may be easily made by those skilled in the art. These changes and modifications are therefore embraced in the scope of the present disclosure. For example, functions and the like implemented as the means or the steps may be rearranged in a logically consistent manner and a plurality of the means or the steps may be combined together or the means or the steps may be further divided.

1. A vehicle comprising:
a container capable of housing a mobile object to be used by a user, wherein
the vehicle is configured to, in accordance with use request information for the mobile object from the user, move to a target location that is determined as at least one of a location at which the user is to rent the mobile object and a location at which the user is to return the mobile object.

2. The vehicle according to claim 1, wherein
the vehicle is configured to, in accordance with the use request information, move to reach the target location by a target time that is determined as at least one of a time at which the user is to rent the mobile object and a time at which the user is to return the mobile object.

3. The vehicle according to claim 1, wherein
the mobile object has a capacity of one person.

4. The vehicle according to claim 1, wherein
the vehicle is configured to move to a location that differs between a case in which the user is to rent the mobile object and a case in which the user is to return the mobile object.

5. The vehicle according to claim 1, further comprising:
a control apparatus configured to control driving of the vehicle to cause the vehicle to move to the target location.

6. The vehicle according to claim 1, further comprising:
a notification apparatus configured to notify a driver of the target location, wherein
the vehicle is configured to be operated by the driver to move to the target location.

7. An information processing apparatus comprising:
a controller configured to control an operation of a first vehicle configured to be capable of housing a mobile object to be used by a user; and
a communication interface configured to be communicatively connected to the first vehicle and a terminal apparatus in the possession of the user, wherein
the controller is configured to receive use request information for the mobile object from the terminal apparatus via the communication interface and control, in accordance with the use request information, operation of the first vehicle to cause the first vehicle to move to a target location that is determined as at least one of a location at which the user is to rent the mobile object and a location at which the user is to return the mobile object.

8. The information processing apparatus according to claim 7, wherein
the controller is configured to determine the target location in accordance with operational information for a second vehicle that can be boarded by the user.

9. The information processing apparatus according to claim 8, wherein
the controller is configured to
output to the terminal apparatus via the communication interface a candidate location that is a candidate for the target location, and
when the user indicates by using the terminal apparatus that the user decides to rent or return the mobile object at the candidate location as the target location, control operation of the first vehicle to cause the first vehicle to move to the target location.

10. The information processing apparatus according to claim 9, wherein
the controller is configured to, when a distance between the target location and a location that is included in the use request information and at which the user desires to rent or return the mobile object is equal to or greater than a predetermined distance, generate information about an incentive to be provided for the user and output the information to the terminal apparatus via the communication interface.

11. The information processing apparatus according to claim 8, wherein
the controller is configured to, in accordance with the use request information, control the operation of the first vehicle to cause the first vehicle to reach the target location by a target time that is determined as at least one of a time at which the user is to rent the mobile object and a time at which the user is to return the mobile object.

12. The information processing apparatus according to claim 11, wherein
the controller is configured to
output to the terminal apparatus via the communication interface a candidate time that is a candidate for the target time, and
when the user indicates by using the terminal apparatus that the user decides to rent or return the mobile object at the candidate time as the target time, control the operation of the first vehicle to cause the first vehicle to reach the target location by the target time.

13. The information processing apparatus according to claim 12, wherein
the controller is configured to, when a time difference between the target time and a time that is included in the use request information and at which the user desires to rent or return the mobile object is equal to or greater than a predetermined time, generate information about an incentive to be provided for the user and output the information to the terminal apparatus via the communication interface.

14. The information processing apparatus according to claim 7, wherein
the mobile object has a capacity of one person.

15. The information processing apparatus according to claim 7, wherein
the controller is configured to determine, as a location at which the user is to return the mobile object, a location different from a location at which the user rented the mobile object.

16. An operations management method comprising:
a step in which an information processing apparatus configured to control operation of a first vehicle configured to be capable of housing a mobile object to be used by a user receives use request information for the mobile object from a terminal apparatus in the possession of the user; and
a step in which the information processing apparatus controls, in accordance with the use request information, operation of the first vehicle to cause the first vehicle to move to a target location that is determined as at least one of a location at which the user is to rent the mobile object and a location at which the user is to return the mobile object.

17. The operations management method according to claim 16, further comprising:
a step in which the information processing apparatus determines the target location in accordance with operational information of a second vehicle that the user is able to ride in.

18. The operations management method according to claim 16, further comprising:
a step in which the information processing apparatus controls, in accordance with the use request information, the operation of the first vehicle to cause the first vehicle to reach the target location by a target time that is determined as at least one of a time at which the user is to rent the mobile object and a time at which the user is to return the mobile object.

19. The operations management method according to claim 16, wherein
the mobile object has a capacity of one person.

20. The operations management method according to claim 16, wherein
the target location in a case in which the user is to return the mobile object is different from a location in a case in which the user rented the mobile object.
